(19) United States
(12) Patent Application Publication
(10) Pub. No.: US 2006/0215237 A1
(43) Pub. Date: Sep. 28, 2006

(54) Image capturing method

(76) Inventor: Shing-Chia Chen, Ciaotou Township (TW)

Correspondence Address: RABIN & Berdo, PC, 1101 14TH STREET, NW, SUITE 500, WASHINGTON, DC, 20005, US

(21) Appl. No.: 11/386,799

(22) Filed: Mar. 23, 2006

(30) Foreign Application Priority Data
Mar. 25, 2005 (TW) 94109487

(51) Int. Cl. H04N 1/04

(52) U.S. Cl. 358/474

(57) ABSTRACT

An image capturing method used in an image capturing device is provided. In the image capturing method, a preview image of N documents is generated by scanning the N documents once, wherein N is a positive integer larger than 1. After that, a scan window having N areas is selected, and the N documents are scanned according to the sizes and the positions of the N areas of the scan window, and then N scanned images are generated once.

This application claims the benefit of Taiwan application Serial No. 94109487, filed Mar. 25, 2005, the subject matter of which is incorporated herein by reference.

### BACKGROUND OF THE INVENTION

1. Field of the Invention

The invention relates in general to an image capturing method, and more particularly to an image capturing method for scanning a scan window having N areas, wherein N is a positive integer larger than 1.

2. Description of the Related Art

A scanner is an universal image capturing and outputting device. FIG. 1 is a flow chart showing a scanning method of a conventional scanner. First, step 100 enables a driver. Next, step 110 generates a preview image of a document to be scanned. Step 120 adjusts several image setting parameters of this preview image, wherein the image setting parameters include the brightness, the contrast, the resolution and so on about image setting. Step 130 adjusts the size and the position of a scan window on the preview image according to a range of an image to be selected by an user. Finally, step 140 scans the document according to the settings made in steps 120 and 130. That is, the document is scanned to generate the desired image according to the selected scan window and the image setting parameters.

In the conventional scanning method, however, the user can only adjust the size and the position on the scan window. So, when the user wants to scan multiple documents, such as photos, business cards, having the same size to generate different scanned images, the documents have to be respectively scanned, and the scan window and the image setting parameters have to be adjusted in each scanning process. If ten documents have to be scanned, steps 110 to 140 have to be preformed ten times.

Alternatively, the user can arrange the documents having the same size on the scan platen, adjust the scan window to cover the area to be scanned and adjust the image setting parameters, and then the documents are scanned. Although this method may need only one time of scanning to generate the image of all the documents, the user has to segment this larger image into smaller images by using the image editing software, and then saves the individual smaller images corresponding to the documents as the image files.

Thus, when multiple documents with the same size have to be scanned to generate multiple images using the conventional scan method, the documents have to be scanned multiple times, or the scanned image has to be segmented by the image editing software. Thus, the scanning process is time-consuming and the scanning cost is high.

### SUMMARY OF THE INVENTION

It is therefore an object of the invention to provide an image capturing method of generating multiple scanned images after scanning multiple documents once by providing a scan window which may be adjusted and divided into multiple areas. Thus, the inconvenience, which is caused by performing scanning processes multiple times or segmenting the image by the image editing software, can be eliminated.

The invention achieves the above-mentioned object by providing an image capturing method used in an image capturing device. The image capturing method generates a preview image of N documents by scanning the N documents once, wherein N is a positive integer larger than 1. After that, a scan window having N areas is provided, and the N documents are scanned according to the sizes and the positions of the N areas of the scan window, and then N scanned images are generated once.

Other objects, features, and advantages of the invention will become apparent from the following detailed description of the preferred but non-limiting embodiment. The following description is made with reference to the accompanying drawings.

### BRIEF DESCRIPTION OF THE DRAWINGS

FIG. 1 (Prior Art) is a flow chart showing a scanning method of a conventional scanner;

FIG. 2 is a flow chart showing an image capturing method according to a preferred embodiment of the invention;

FIG. 3A is a schematic illustration showing the arrangement of the documents on a scan platen; and

FIG. 3B is a schematic illustration showing a scan window SW segmented into nine areas.

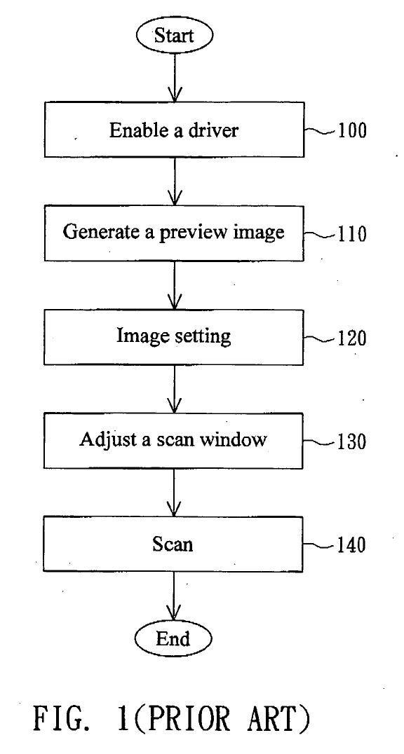

### DETAILED DESCRIPTION OF THE INVENTION

In the conventional scan window, only the size and the position can be adjusted. Thus, when the user wants to scan multiple documents having the same size, such as photos, business cards, or the like, the documents having the same size have to be individually scanned, and the scan window and the image setting parameters have to be adjusted in a time-consuming manner.

The invention provides an image capturing method used in an image capturing device. The image capturing method generates a preview image of N documents by scanning the N documents once, wherein N is a positive integer larger than 1. After that, a scan window having N areas is selected, and the N documents are scanned according to the sizes and the position of the N areas of the scan window, and then N scanned images are generated once. Thus, the user can obtain multiple scanned images corresponding to the documents having the same size in a timesaving and convenient manner by scanning the documents only once.

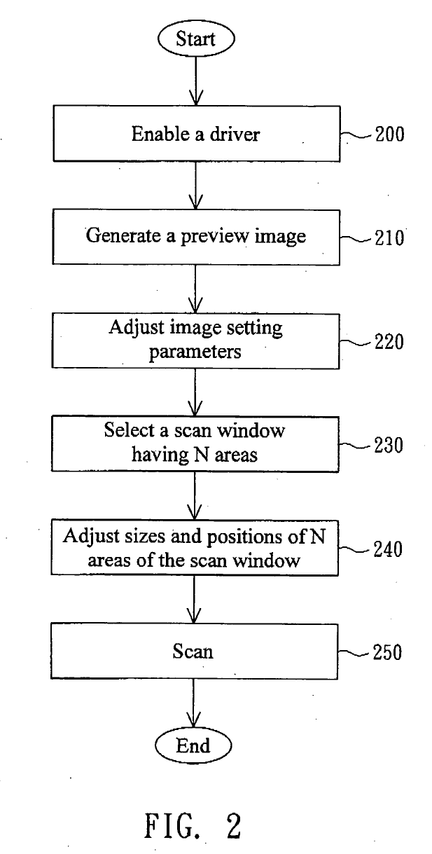

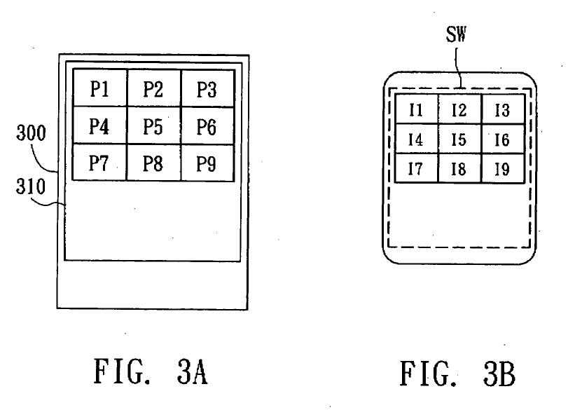

FIG. 2 is a flow chart showing an image capturing method according to a preferred embodiment of the invention. The image capturing method of this embodiment is used in an image capturing and outputting device, such as a scanner 300 as depicted in FIG. 3A. The method includes the following steps. First, step 200 enables a driver to drive the scanner 300. Next, step 210 generates a preview image of N documents. That is, the scanner 300 pre-scans the N documents. Next, step 220 adjusts several image setting parameters of this preview image, wherein the image setting parameters includes the brightness, the contrast and the resolution, for example. In step 230, a scan window SW is selected, wherein the scan window SW having N areas. N is the number of the scan window to be segmented and belonging to a positive integer lager than 1. Then, step 240 adjusts the sizes and the positions of the N areas of the scan window SW. Finally, step 250 scans the N documents according to the scan window SW and the image setting parameters to generate N scanned images. That is, the user can adjust and segment the scan window SW into N areas, which have rectangular shapes that are substantially the same and are arranged in a matrix. For example, when the documents are nine photos having the same size, the user may select a scan window having nine areas and adjust the scan window SW in step 230, such that every area corresponds to the sizes of every photo and the position of the image of the photo on the preview image. Finally, step 250 scans the nine documents according to the settings made in steps 220 to 240. That is, the nine documents are scanned once according to the selected scan window SW and the image setting parameters so that the nine scanned images are generated.

The details will be described with reference to FIGS. 3A and 3B. FIG. 3A is a schematic illustration showing the arrangement of the documents on a scan platen. FIG. 3B is a schematic illustration showing a scan window SW. As shown in FIG. 3A, when nine documents with the same size P1 to P9 have to be scanned, the documents may be orderly arranged on a scan platen 310 of the scanner 300. Next, the steps 200 and 210 are performed to generate the preview image as FIG. 3B, and the steps 220 to 240 are performed to adjust and segment the scan window SW on the preview image into nine areas L1 to L9 having the sizes and the positions corresponding to the documents P1 to P9, as shown in FIG. 3B. Next, step 250 is performed to scan the documents and obtain nine scanned images I1 to I9 corresponding to the nine documents P1 to P9. Thus, the user only has to scan the documents only once to obtain scanned images I1 to I9 corresponding to the documents P1 to P9. It can solve the problem of wasting time to scan the documents having the same size individually in the prior art and to adjust the scan window and the image setting parameters every time.

In addition, the scanner driver of this embodiment may have build-in the scan windows SW corresponding to the common document sizes, such as those of the photos of the sizes of 3×5, 4×6, 5×7 or business cards and the like. The user only has to orderly arrange the documents on the scan platen 310 according to the areas divided by the scan window SW without cropping the scan window SW corresponding to the document images. In addition, it is also possible to select several areas, which are to be scanned, from the build-in scan window SW having multiple areas.

Under the same design concept, the image capturing method may further be used in a copier or a multi-function printer. When the image capturing device is the copier, an adjustable scan window may be provided on an user interface, such as the copier of a liquid crystal display. According to the spirit of the embodiment, the scan window also can be adjusted and segmented into N areas corresponding to N ranges to be scanned. Finally, N images are printed according to the set N areas and the image setting parameters, such as the sheet size of the copier. Alternatively, when the image capturing device is a multi-function printer, the user interface such as a liquid crystal display on the multi-function printer or the user interface on the computer system connected to the peripheral may provide the adjustable scan window, such that N scanned images may be obtained according to the set N areas and the image setting parameters.

The image capturing method according to the embodiment of the invention can scan multiple documents only once to obtain multiple scanned images. Thus, it is unnecessary to spend time to adjust the image setting parameters and the scan window every time before the document is scanned. So, the efficiency can be improved and the cost can be reduced.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image capturing method used in an image capturing device, comprising:
scanning N documents, wherein N is a positive integer larger than 1;
generating a preview image of the N documents;
selecting a scan window having N areas; and
scanning the N documents according to sizes and positions of the N areas of the scan window and generating N scanned images once.

2. The method according to claim 1, further comprising:
adjusting a plurality of image setting parameters of the preview image.

3. The method according to claim 2, wherein the image setting parameters comprises one of brightness, contrast and resolution.

4. The method according to claim 1, further comprising:
adjusting the sizes and the positions of the N areas of the scan window to crop image ranges to be scanned.

5. The method according to claim 1, wherein the N areas have rectangular shapes which are substantially the same.

6. The method according to claim 1, wherein the N areas are arranged in a matrix.

7. The method according to claim 1, wherein the image capturing device is a scanner.

8. The method according to claim 1, wherein the image capturing device is a copier.

9. The method according to claim 1, wherein the image capturing device is a multi-function printer.
